(19) United States
(12) Patent Application Publication
(10) Pub. No.: US 2022/0277418 A1
(43) Pub. Date: Sep. 1, 2022

(54) METHOD AND ELECTRONIC PORTAL SYSTEM FOR BUILDING FAÇADE INSPECTION

(71) Applicant: AeroSpect Inc., Brooklyn, NY (US)

(72) Inventors: Edward Kostakis, Mineola, NY (US); Pablo Barrera, Ridgewood, NY (US); Scott Ryan Harrigan, Oyster Bay, NY (US)

(21) Appl. No.: 17/681,085

(22) Filed: Feb. 25, 2022

Related U.S. Application Data
(60) Provisional application No. 63/154,246, filed on Feb. 26, 2021.

(51) Int. Cl. G06T 3/40; G06F 16/587; G06F 3/04817; B64C 39/02

(52) U.S. Cl. CPC G06T 3/4038; G06F 16/587; G06F 3/04817; B64C 39/024; G06T 2200/32; B64C 2201/123; B64C 2201/127

(57) ABSTRACT

A method for building façade inspection includes: acquiring individual local images of a building façade; creating local image positions and an orthomosaic from a subset of the acquired local images of the building façade, a plurality of two- or three-dimensional data relating to the building façade and/or features and dimensions indicated in a computer-aided design drawing of the building façade; generating a visual image database correlating each local image position to a corresponding user-selectable link for accessing and presenting a close-up of that image location to a user, the visual image database including one or more non-nadir local images; displaying an overall combined image of the building façade, with the visual image database overlaying the orthomosaic; and adding user-interactive elements to the visual image database that correlate a region of interest (ROI) in the orthomosaic with at least one of the individual local images corresponding to the prescribed ROI.

### CROSS-REFERENCE TO RELATED APPLICATIONS

This application claims priority to U.S. Provisional Patent Application No. 63/154,246 filed Feb. 26, 2021 entitled “Method and Electronic Portal System for Building Façade Inspection,” the disclosure of which is incorporated by reference herein in its entirety for all purposes.

### BACKGROUND

The present invention relates generally to aerial imaging, and more particularly to methods and apparatus for building façade inspection using unmanned aerial vehicles (UAVs).

In conducting visual inspections on the façade of a building, it is known to have inspectors use scaffolds to scale and physically inspect the façades. However, the cost of such hands-on, up-close inspections, including the scaffolding rental/purchase and set-up they entail, can add significant cost, time and danger to the inspection process. Furthermore, the costs and risk of danger increase proportionally with the height of the building being inspected.

More recently, it is known to use unmanned aerial vehicles (UAVs), often referred to as aerial drones, to perform visual inspection of a building. Such drones typically use global positioning system (GPS) coordinates to automate the flight pattern of the drone and to reference the drone images of the building surface. While this may be suitable for obtaining visual inspection of horizontal building surfaces, such as a roof, the use of aerial drones for obtaining images of vertical building surfaces, such as the façade, has remained problematic. This is due, at least in part, to the fact that discrimination of vertical distances using GPS information is highly inaccurate. Furthermore, buildings (particularly skyscrapers) often obstruct the reception of GPS signals, thus making the reliance on GPS data for piloting the drones and capturing images of the building façade impractical.

### SUMMARY

Aspects of the present invention, as manifested in one or more embodiments thereof, provide methods and an electronic portal system for facilitating building façade inspection. The inspection portal is comprised of a façade orthomosaic integrated with a visual image database. The façade orthomosaic includes a plurality of individual unmanned aerial vehicle (UAV)-acquired still images stitched together to form a geometrically accurate image map of an overall building façade. The visual image database combines each local image position, indicated using a pin or other indicator overlaying the façade orthomosaic, with a hyperlink to the corresponding stored image. In this manner, an inspector who desires to see enhanced detail of a particular region of interest on the façade can select one of the pins, thereby causing a more detailed image of the corresponding region of interest to be presented.

In accordance with one embodiment of the invention, a method for facilitating building façade inspection includes: acquiring, using a UAV, multiple individual local images of a building façade; creating local image positions and an orthomosaic from at least one of a subset of the acquired plurality of individual local images of the building façade, a plurality of two- or three-dimensional data relating to the building façade, and features and dimensions indicated in a computer-aided design drawing of the building façade; generating a visual image database that correlates each local image position to a corresponding user-selectable link for accessing and presenting a close-up of that image location to a user, the visual image database including one or more non-nadir local images; displaying an overall combined image of the building façade, with the visual image database overlaying the orthomosaic; and adding multiple user-interactive elements to the visual image database, each of the user-interactive elements correlating a prescribed region of interest in the orthomosaic with at least one of the plurality of individual local images corresponding to the prescribed region of interest on the building façade.

In accordance with another embodiment of the invention, a computer-based building façade inspection system includes memory and at least one processor coupled with the memory. The processor is configured: to obtain individual local images of a building façade acquired by a UAV; to create local image positions and an orthomosaic from at least a subset of the plurality of individual local images of the building façade and two- or three-dimensional data relating to the building façade and/or features and dimensions indicated in a computer-aided design drawing of the building façade; to generate a visual image database that correlates each local image position to a corresponding user-selectable link for accessing and presenting a close-up of that image location to a user, the visual image database including one or more non-nadir local images; to display an overall combined image of the building façade, with the visual image database overlaying the orthomosaic; and to add a plurality of user-interactive elements to the visual image database, each of the user-interactive elements correlating a prescribed region of interest in the orthomosaic with at least one of the plurality of individual local images corresponding to the prescribed region of interest on the building façade.

As may be used herein, “facilitating” an action includes performing the action, making the action easier, helping to carry the action out, or causing the action to be performed. Thus, by way of example only and without limitation, for embodiments of the invention that employ multiple processors configured in a distributed manner, instructions executing on one processor might facilitate an action carried out by instructions executing on another processor, by sending appropriate data or commands to cause or aid a requested action to be performed. For the avoidance of doubt, where an actor facilitates an action by other than performing the action, the action is nevertheless performed by some entity or combination of entities.

One or more embodiments of the invention, or elements thereof, may be implemented in the form of a computer program product including a computer readable storage medium with computer usable program code for performing the method steps indicated. Furthermore, one or more embodiments of the invention or elements thereof may be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) may be configured to implement the specific techniques set forth herein.

Techniques of the present invention can provide substantial beneficial technical effects. By way of example only and without limitation, one or more embodiments may provide one or more of the following advantages:
Provides high-resolution image data for building façade inspection presented in a convenient user interface.
Provides a high-resolution orthomosaic image and photographic set of images for time-based digital recordkeeping of structural characteristics of the building façade. These conditions are stored as a set of “snapshots” of the entire façade, and can therefore be used to visually compare and contrast conditions of the façade over time.
Provides a visual historical record of buildings that may be demolished, damaged by natural weather or other events, or deteriorated significantly over time. The source imagery is sufficient enough for architectural reconstruction of a façade based on the high-resolution orthomosaic.
Provides a method and database architecture that may be either hosted online (via cloud storage, web interface, and hyperlinks) offline (via local files and computers in a desktop embodiment), or a hybrid of both.
Stores and exports photo location and user-input data in industry-standard GIS and CAD formats such as comma separated value spreadsheets (CSV files), geographic information system (GIS) shapefiles (SHP files), and computer-aided design (CAD) drawing files (DXF files), for high compatibility and interoperability with software and databases across many organizations, entities, or platforms wishing to utilize the data.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIGS. 1A and 1B are flow diagrams depicting at least a portion of an exemplary method for implementing an electronic portal for building façade inspection, according to one or more embodiments of the present invention;

FIG. 2 conceptually depicts an exemplary drone flight pattern that can be used to traverse a building façade for the purpose of capturing local images of the building façade, according to an embodiment of the present invention;

FIG. 3A conceptually illustrates an exemplary visual image database overlaying an orthomosaic of a building façade, including a plurality of user-selectable pins, according to an embodiment of the present invention;

FIG. 3B conceptually depicts at least a portion of an exemplary graphical user interface (GUI) included in a façade inspection portal, in accordance with one or more embodiments of the present invention;

FIG. 4 conceptually illustrates exemplary user-interactive elements added to the façade inspection portal, according to an embodiment of the invention;

FIGS. 5A-5C are exemplary screen shots of a web-based inspection portal depicting user-selectable icons overlying a building façade orthomosaic that can be used to access different types of local images of corresponding regions of interest, according to embodiments of the present invention; and

FIG. 6 conceptually depicts an exemplary methodology which utilizes multiple fixed (e.g., ground-based) sensors to automate the piloting of an aerial drone for capturing local building façade images and related sensor data, according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of the present invention will be described herein in the context of methods and an electronic portal system for building façade inspection using unmanned aerial vehicle (UAV)-acquired images. It is to be appreciated, however, that the specific system and/or methods illustratively shown and described herein are to be considered exemplary rather than limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

As previously stated, UAVs, often referred to as aerial drones, can be utilized to perform visual inspection of a building. Conventionally, drones typically use global positioning system (GPS) coordinates to automate the flight pattern of the drone and to reference the drone images of horizontal building surfaces, such as a roof. However, the use of aerial drones for obtaining images of vertical building surfaces, such as the building façade, has remained problematic.

Advantageously, aspects of the present invention provide a method and an electronic portal system which facilitates building façade inspection. The inspection portal is comprised of a façade orthomosaic integrated with a visual image database. The façade orthomosaic includes a plurality of individual UAV-acquired still images digitally stitched together to form a geometrically accurate image map of an overall building façade. The visual image database combines each local image position, indicated using a pin or other indicator overlaying the façade orthomosaic, with a hyperlink to the corresponding stored image. In this manner, a building inspector who desires to view enhanced detail of a particular area of the façade can select one of the pins, thereby causing an image of the corresponding region of interest to be presented.

User-interactive elements and features are added to the visual image database which allows a user to click on a visual representation of each local image position, which calls up the web or local hard drive hyperlink to allow presentation of a detailed image of the corresponding location on the façade. The unique display of this data together allows a façade inspector to view an entire façade at once, with visual representations of local image positions. When accessed, such as by clicking on a hyperlink, the visual representation displays the individual detailed image found at that position. All data is preferably stored in transferrable formats for further display in a wide variety of graphic information system (GIS) and/or computer-aided design (CAD) applications by others. Embodiments of the invention focuses on the unique display of the data, and the novel methods employed to retrieve data and to generate such a display.

The façade orthomosaic, in one or more embodiments, is created using standard photogrammetry, whereby respective local image positions represent local-coordinate specific locations of images. Three-dimensional information relating to GPS coordinate data contained in the photogrammetry output is stripped in the generated orthomosaic to decouple the GPS data from a local vertical projection plane generated according to aspects of the invention, resulting in a vertical two-dimensional image of the building façade. As will be explained in further detail herein below, three-dimensional representations obtained from local images acquired by the aerial drone that are correlated to the building façade orthomosaic are retained for beneficially displaying localized relief (e.g., overhangs, underhangs, etc.) and/or localized orthogonality of the building façade.

In one or more embodiments, an aerial drone or other UAV can be manually piloted, traversing the face of a building in a grid-like pattern to acquire the individual images of the building façade. The present invention also contemplates an autonomous (and interactive) method for piloting the drone over an effective data-gathering flight path. Close up imagery (e.g., photographs) of certain areas of interest on the building façade are preferably acquired at regular intervals and/or manually. GPS data corresponding to the images can be acquired if available. In some embodiments, one or more sensors are attached to the drone and the sensor data is correlated to the acquired images. Such sensor data that can be correlated to the individual images includes, but is not limited to, thermal, pressure, air quality, wind speed, solar (UV) intensity, etc.

The local coordinate system data is preferably correlated to and stored with the acquired images in generating the visual image. As previously stated, since it is generally difficult to discriminate vertical location of the drone using GPS coordinates, the drone preferably employs a local coordinate system that is substantially disconnected (i.e., decoupled) from GPS-based control. The local coordinate system, in one or more embodiments, is based at least in part on building measurements obtained from actual architectural building dimensions and specifications. Alternatively, surveyor ground points may be used. For example, sensors on the ground may be configured to create a digital wall or a geofence, thereby creating a virtual perimeter for automatically piloting the drone. A geofence can be dynamically generated, as in a radius around a point location, or a geofence may comprise a predefined set of boundaries.

Regardless of the method used to obtain the individual local image data, the drone should be kept at a substantially constant stand-off from the building façade to ensure consistent dimensions between each local image when capturing nadir-type (i.e., head-on; perpendicular to the building) images. Maintaining a constant building stand-off can be achieved, in one or more embodiments, using laser range-finding (LiDAR), visual detection and ranging (ViDAR), or other noncontact distance measurement schemes. By maintaining a constant stand-off, a perspective for each of the acquired local images is consistent with one another, which provides for a more geographically accurate rendering of the overall building façade orthomosaic.

Before, after, or concurrently with the nadir imagery, oblique or non-nadir imagery (usually, but not limited to, about 30-45 degree angle upward and/or downward) is also captured of building overhangs and underhangs, when present, which are later localized and visually indicated on the electronic inspection portal. This oblique imagery is desirable in providing localized information regarding a three-dimensional contour of the building façade; retaining these non-nadir type local images facilitates a more thorough inspection of all surfaces of the building façade, rather than just the purely vertical surfaces.

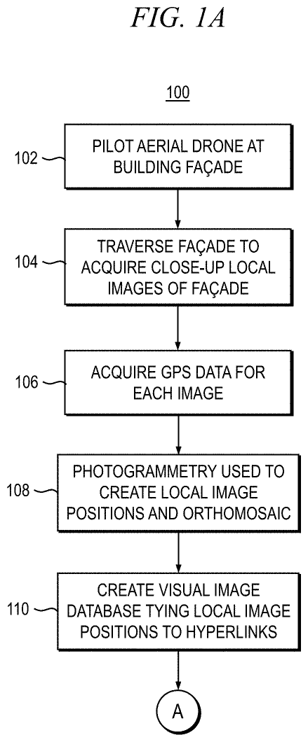

FIGS. 1A and 1B are flow diagrams depicting at least a portion of an exemplary method 100 for implementing an electronic portal for building façade inspection, according to an embodiment of the invention. In a first step 102, an aerial drone or UAV is piloted, either manually or autonomously (e.g., using software, pattern recognition, geofence sensors, etc.), at the façade of a building under inspection. The drone preferably traverses the face of the building in step 104 to acquire individual local images of the building façade. The imagery performed in step 104 comprises close-up photos of the façade acquired at prescribed and/or regular locations as the drone traverses the building façade.

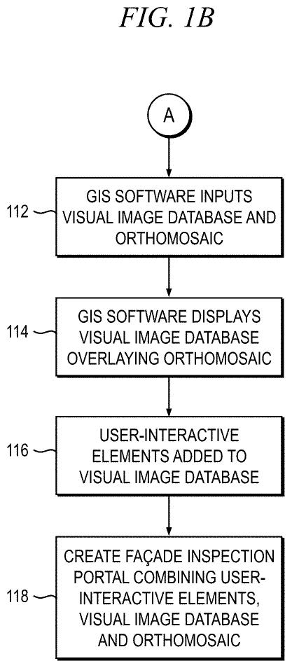

FIG. 2 conceptually depicts an exemplary aerial drone flight pattern 202 that can be used to traverse a building façade 204 for the purpose of capturing local images of the building façade, according to an embodiment of the invention. Although in this illustration a grid-like drone flight pattern is employed, it is to be appreciated that the invention is not limited to any specific flight pattern used for capturing the plurality of local building façade images.

With continued reference to FIGS. 1A and 1B, in step 106, GPS data for each acquired image location may be captured, when available. Alternatively, or additionally, the drone may capture location data for each acquired image using a local coordinate system. As previously stated, when equipped with other sensors, such as, for example, a thermal (e.g., infrared) sensor, pressure sensor, ultraviolet (UV) radiation sensor, anemometer, etc., the drone may capture additional data corresponding to each acquired image location at step 106, including, but not limited to, thermal, pressure, air quality, solar intensity, wind speed, etc. This additional information can be subsequently used by a building engineer in making decisions regarding certain design parameters of the building.

In step 108, photogrammetry software (e.g., Autodesk ReCap, from Autodesk Inc.) is used to create local image positions and an orthomosaic from the acquired local building façade images. In generating the orthomosaic of the building façade, respective local image positions represent local-coordinate specific locations of the images. Three-dimensional GPS data normally contained in the photogrammetry output is preferably removed in the generated orthomosaic, leaving a vertical two-dimensional image of the building façade. Two-dimensional coordinate data of an existing building façade, such as from an architectural CAD drawing or other source of building dimensions, if available, can be utilized to replace at least a portion of the three-dimensional GPS data, resulting in a visual database coordinate system and local image positions that are consistent with existing building measurements.

A visual image database is created in step 110 that correlates each local image position to a corresponding user-selectable link (e.g., hyperlink) for accessing and presenting a close-up of that image location to a user. In the visual image database, three-dimensional information acquired from non-nadir type images are retained for advantageously displaying localized relief (e.g., overhangs, underhangs, etc.) and/or localized orthogonality of the building façade, as previously stated.

The visual image database and the orthomosaic of the building façade are then presented to GIS software, or an alternative correlation program, in step 112. In step 114, the GIS software is preferably configured to display an overall combined image of the building façade, with the visual image database overlaying the orthomosaic. User-interactive elements and features are added to the visual image database in step 116. For example, each local image position in the visual image database is preferably indicated on the orthomosaic using a pin or other indicator, with a selectable link to the corresponding stored close-up image. In this manner, when a user selects (e.g., clicks on, mouses-over, etc.) the pin, a link is activated and a corresponding close-up image of that particular correlated location is displayed which includes enhanced detail of the selected region of interest of the building façade. User-interactive elements may also include user-inputted features, such as polygons or other icons drawn directly on top of the façade orthomosaic, to denote corresponding regions of interest. These features are capable of being downloaded into a variety of other formats, compatible with CAD or GIS programs, while retaining their local coordinates, geometric properties, and other user-added attributes. These user-interactive elements and features are combined with the visual image database and orthomosaic to generate a façade inspection portal in step 118 which provides a single, intuitive platform that beneficially facilitates building façade inspections.

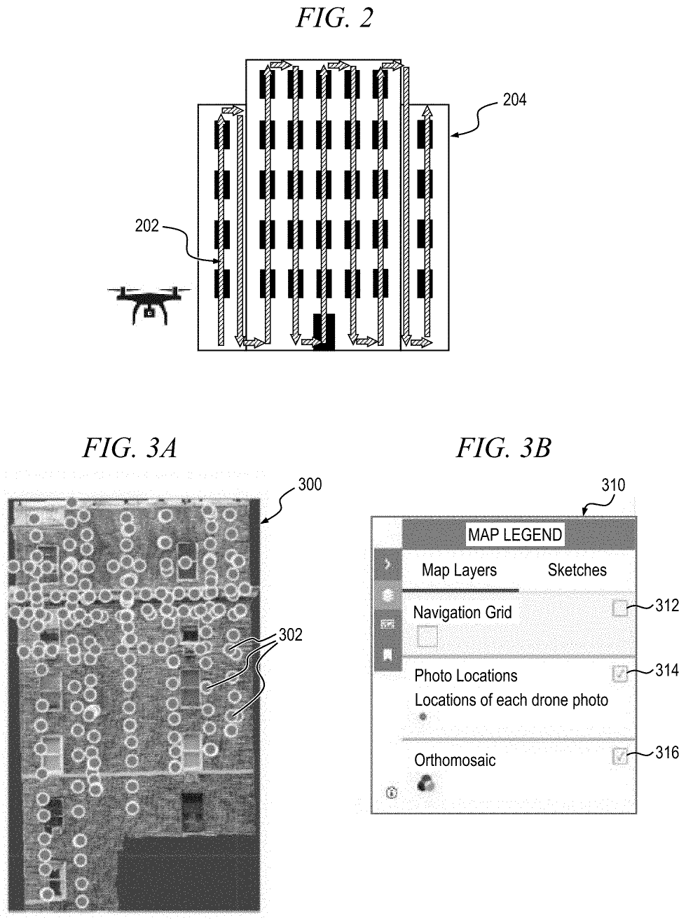

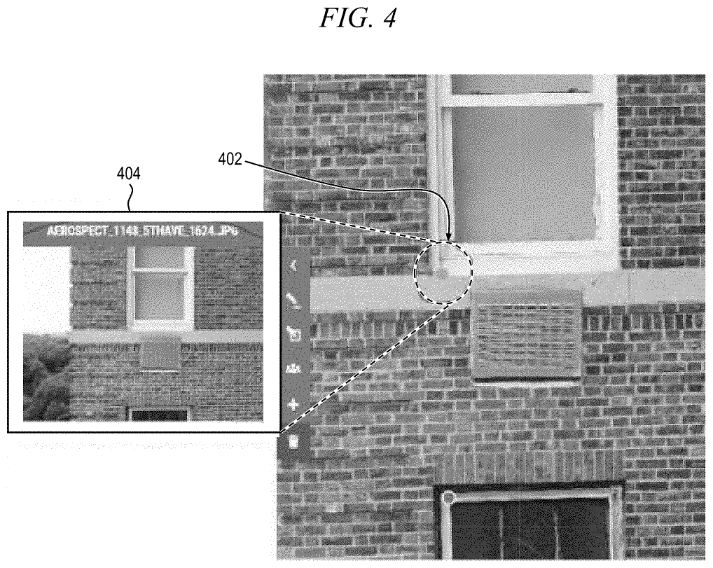

FIG. 3A conceptually illustrates at least a portion of an exemplary visual image database overlaying an orthomosaic of a building façade 300, including a plurality of user-selectable pins 302, according to an embodiment of the invention. Each pin 302 represents a selectable link to a close-up image corresponding to that local image location on the building façade. FIG. 3B conceptually depicts at least a portion of an exemplary graphical user interface (GUI) included in a façade inspection portal 310 in accordance with one or more embodiments of the invention. As shown in FIG. 3B, the inspection portal 310 includes user-selectable menu items (e.g., boxes) 312, 314 and 316 that allow the user to individually turn on or off certain layers of the overall building façade map, including a navigation grid, photo locations and orthomosaic, respectively, in this example.

In one or more embodiments, additional information (e.g., thermal, pressure, air quality, solar intensity, wind speed, etc.) captured by the aerial drone and correlated to the individual local image locations on the building façade may be presented overlaying the orthomosaic 300. This additional information (not explicitly shown, but implied) may be displayed as separate layers on the orthomosaic 300 that can also be turned on or off under user control through the inspection portal 310.

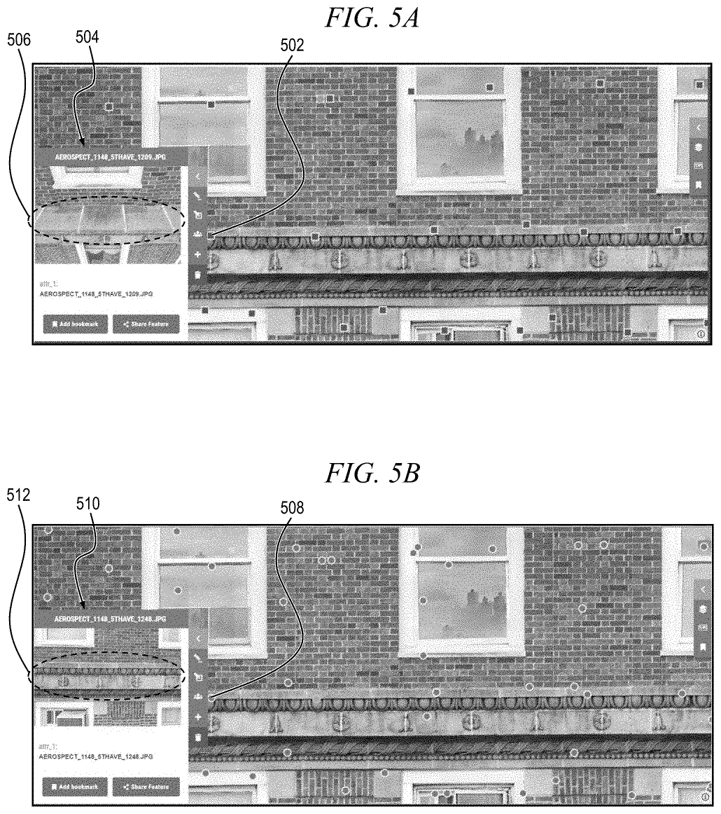

FIG. 4 conceptually illustrates exemplary user-interactive elements added to the façade inspection portal, according to an embodiment of the invention. As apparent from FIG. 4, by selecting (e.g., clicking, mousing-over, etc.) a single element of the visual image database overlaying the orthomosaic representing a given region of interest 402, a hyperlink is activated which displays the individual photo 404 corresponding to that image location, enabling the user to view a close-up of the selected region of interest.

In one or more embodiments, other interactive features can be added by a user, such as polygons or other shapes and symbols, displayed directly on the orthomosaic to indicate regions of interest, or alternative views of a selected region of interest. When downloaded by the user, the orthomosaic and corresponding symbols are preferably compatible with actual computer-aided design (CAD) drawings of the building that an architect will have available. Thus, anything that the user draws on the orthomosaic can be easily downloaded and will correlate nicely with the actual building, through use of the local coordinates and dimensions. In this regard, preferably all downloaded data will be aligned in the same coordinate system as any user-provided original measurements, such as from an existing CAD drawing of the building.

In capturing the local images of the building façade, some of the images may not necessarily be in the same projection plane as the rest of the façade images. This is particularly true where the building has overhangs, underhangs and/or other projections that are not parallel in relation to the building face. Since inspection of these non-parallel projections of the building façade may be required, embodiments of the invention beneficially retain all of these local images, which can then be viewed by selecting an appropriate link on the orthomosaic. In order to capture these non-parallel projections, one or more embodiments may employ printable Quick Response (QR) codes, computer vision targets, or the like, adapted to be adhered to the building, for example on windows, printed on window blinds, etc., that are coded uniquely and serve as building control points.

In one or more embodiments, the façade inspection portal, which is preferably a web-based platform, allows a user to discriminate between viewing a nadir (i.e., forward-facing) type image of a given region of interest and a non-nadir type image by utilizing different colors, shapes, iconography, etc., displayed on the building façade orthomosaic. To implement this feature, the user may select a specific icon to access a corresponding image of the selected type. Icons, colors, and other representations are utilized in identifying the type of image, such as, for example, head-on view, overhang (e.g., 45-degree downward view), underhang (e.g., 45-degree upward view), etc. Representations identifying the type of image can also be displayed on the building façade orthomosaic based on content of the image, such as, for example, a door, wall, window, brick, parapet, crown, etc.

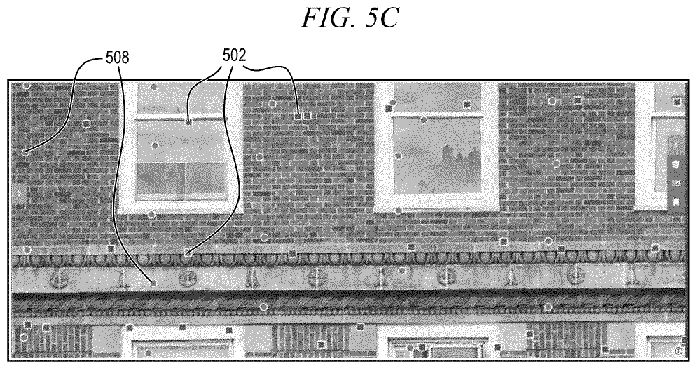

FIGS. 5A-5C are exemplary screen shots of a web-based inspection portal depicting user-selectable icons overlying a building façade orthomosaic that can be used to access different types of local images of corresponding regions of interest, according to embodiments of the invention. As shown in FIG. 5A, red square icons 502 are displayed on the inspection portal which, when selected by a user (e.g., clicking or mousing-over the icon), are used to access and present corresponding non-nadir images 504 of prescribed regions of interest 506. In this example, the displayed image 504 is a non-nadir type image illustrating a top surface of a ledge which is perpendicular to the building façade. In FIG. 5B, blue circle icons 508 are displayed on the inspection portal which, when selected by a user, are used to access and present corresponding nadir images 510 of prescribed regions of interest 512. In this example, the displayed image 510 is a nadir-type image depicting a front face of the ledge.

The inspection portal, in one or more embodiments, may provide the user with the ability to turn on or off local image links based on the type of image being represented. This feature may be implemented in a manner consistent with the turning on or off of selected layers via the portal, as shown in FIG. 3B. Alternatively, FIG. 5C shows how different types of icons can be displayed concurrently on the same orthomosaic in a manner which provides clear discrimination of the image type. In this example, red square icons 502 represent non-nadir images of corresponding regions of interest, and blue circle icons 508 represent nadir images of corresponding regions of interest. It is to be appreciated that embodiments of the invention contemplate numerous other ways for differentiating the different types of images that can be presented of selected regions of interest on the building façade orthomosaic.

As previously stated, in order to capture local images of the building façade, the drone is piloted, either manually or autonomously, at the façade of a building under inspection. Although it is known to automatically pilot a drone using GPS coordinates, when the drone is used for traversing the face of a building, GPS coordinates are not capable of accurately discriminating vertical distances. Furthermore, buildings, especially tall buildings, often obstruct the reliable reception of GPS signals by the drone. One method to overcome this problem, according to embodiments of the invention, is to employ a plurality of fixed sensors to create a virtual (i.e., digital) perimeter that can be used to guide an automated drone flight plan.

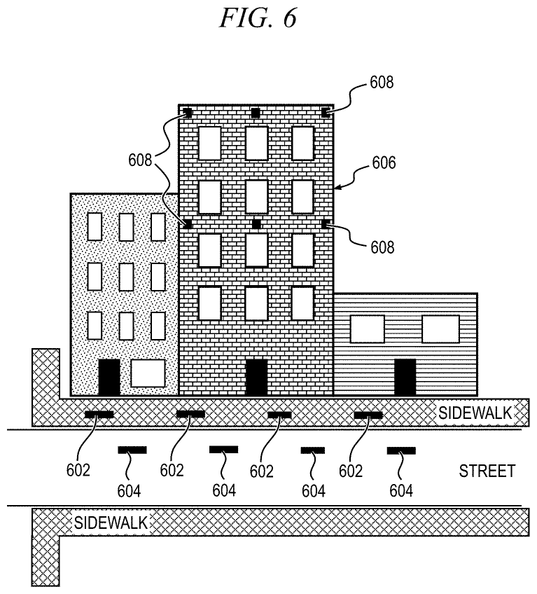

FIG. 6 conceptually depicts an exemplary methodology which utilizes multiple fixed (e.g., ground-based) sensors to automate the piloting of a drone for capturing local building façade images and related sensor data, according to an embodiment of the invention. In this illustrative embodiment, a plurality of ground-based sensors are used, including sensors 602 placed at prescribed locations on (or embedded in) a sidewalk adjacent to the building under inspection, and sensors 604 placed at prescribed locations on (or embedded in) an adjacent street. These sensors create a virtual perimeter within which the drone is autonomously piloted to vertically traverse the façade of a building 606 for capturing local images and other data relating to the building façade. Alternatively, or additionally, a plurality of sensors 608 can be added to the façade of the building or to the structure of the building itself (either permanently or temporarily) at prescribed locations, thereby creating the same virtual perimeter or a virtual shield to the building so the drone does not approach the building within a predetermined distance.

Similar to the use of sensors on the façade of the building, in one or more embodiments, printable QR codes, computer vision targets, or the like, adapted to be adhered to the building (e.g., on windows, printed on window blinds, etc.) may be coded uniquely and serve as building control points, as previously mentioned. These targets can be measured independently by a surveyor or simply used as common identifiers between photos. The use of printed QR codes/target checkerboards and the like attached to the inside of windows and/or printed on window blinds distributed to building tenants, etc., could be employed as a solution to the “sensor-standoff” issue in a cost effective manner.

In one or more embodiments, the local image positions and the orthomosaic are stored to create a historical (i.e., time-based) digital record of the structural characteristics and features of the building façade. These stored historical local image positions and orthomosaic of the building façade can be compared with currently acquired local image positions and an orthomosaic of the building façade to evaluate how a condition of the building façade has changed over time. Furthermore, the digital record can be used to restore at least portions of the building façade that have deteriorated.

The illustrations of embodiments of the invention described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the invention are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “above” and “below” are used to indicate relative positioning of elements or structures to each other as opposed to relative elevation.

The corresponding structures, materials, acts, and equivalents of all means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the various embodiments with various modifications as are suited to the particular use contemplated.

The abstract is provided to comply with 37 C.F.R. § 1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus, the following claims are hereby incorporated into the Detailed Description, with each claim standing on its own as separately claimed subject matter.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

What is claimed is:

1. A method for facilitating building façade inspection, the method comprising:
acquiring, using an unmanned aerial vehicle (UAV), a plurality of individual local images of a building façade;
creating local image positions and an orthomosaic from at least a subset of the acquired plurality of individual local images of the building façade and at least one of a plurality of two- or three-dimensional data relating to the building façade, and features and dimensions indicated in a computer-aided design drawing of the building façade;
generating a visual image database that correlates each local image position to a corresponding user-selectable link for accessing and presenting a close-up of that image location to a user, the visual image database including one or more non-nadir local images;
displaying an overall combined image of the building façade, with the visual image database overlaying the orthomosaic; and
adding a plurality of user-interactive elements to the visual image database, each of the user-interactive elements correlating a prescribed region of interest in the orthomosaic with at least one of the plurality of individual local images corresponding to the prescribed region of interest on the building façade.

2. The method according to claim 1, further comprising creating a building façade inspection portal that integrates the plurality of user-interactive elements, the visual image database and the orthomosaic into a single platform for facilitating building façade inspections by a user.

3. The method according to claim 1, wherein acquiring the plurality of individual local images of the building façade comprises causing the UAV to traverse the building façade to obtain and store individual local still images of the building façade at prescribed time intervals or at prescribed locations on the building façade.

4. The method according to claim 3, further comprising piloting the UAV using one of a manual and an autonomous flight pattern across the building façade.

5. The method according to claim 1, wherein creating the orthomosaic comprises digitally stitching together at least the subset of the acquired plurality of individual local images of the building façade to form a geometrically accurate image map of the building façade.

6. The method according to claim 1, further comprising capturing at least one of global positioning system (GPS) data, thermal data, pressure data, air quality data, solar intensity data, wind speed data, and building control points comprising at least one of Quick Response (QR) codes and computer vision targets adapted to be adhered to the building, for each of at least a subset of the plurality of individual local images of the building façade.

7. The method according to claim 1, further comprising capturing location information corresponding to each of at least a subset of the plurality of individual local images of the building façade using a local coordinate system.

8. The method according to claim 1, wherein adding the plurality of user-interactive elements to the visual image database comprises overlaying a plurality of user-selectable icons on the orthomosaic, each of the icons, when activated by a user, causing a stored local image of a corresponding location on the building façade to be displayed.

9. The method according to claim 1, wherein the two- or three-dimensional data relating to the building façade comprises global positioning system (GPS) coordinate information.

10. The method according to claim 1, wherein the visual image database comprises one or more nadir local images.

11. The method according to claim 1, further comprising comparing the local image positions and the orthomosaic with stored historical local image positions and an orthomosaic of the building façade for determining how a condition of the building façade has changed over time.

12. The method according to claim 1, further comprising storing the local image positions and the orthomosaic to generate a time-based digital record of structural characteristics of the building façade for visually comparing and contrasting conditions of the building façade over time.

13. A computer-based building façade inspection system, comprising:
memory; and
at least one processor coupled with the memory, the at least one processor being configured:
to obtain a plurality of individual local images of a building façade acquired by an unmanned aerial vehicle (UAV);
to create local image positions and an orthomosaic from at least a subset of the plurality of individual local images of the building façade and at least one of a plurality of two- or three-dimensional data relating to the building façade, and features and dimensions indicated in a computer-aided design drawing of the building façade;
to generate a visual image database that correlates each local image position to a corresponding user-selectable link for accessing and presenting a close-up of that image location to a user, the visual image database including one or more non-nadir local images;
to display an overall combined image of the building façade, with the visual image database overlaying the orthomosaic; and
to add a plurality of user-interactive elements to the visual image database, each of the user-interactive elements correlating a prescribed region of interest in the orthomosaic with at least one of the plurality of individual local images corresponding to the prescribed region of interest on the building façade.

14. The system according to claim 13, wherein the at least one processor is further configured to create a building façade inspection portal that integrates the plurality of user-interactive elements, the visual image database and the orthomosaic into a single interface platform for facilitating building façade inspections by a user.

15. The system according to claim 13, wherein to acquire the plurality of individual local images of the building façade, the at least one processor is configured to control the UAV to traverse the building façade to obtain and store individual local still images of the building façade at prescribed time intervals or at prescribed locations on the building façade.

16. The system according to claim 13, wherein in creating the orthomosaic, the at least one processor is configured to digitally stitch together at least the subset of the acquired plurality of individual local images of the building façade to form a geometrically accurate image map of the building façade.

17. The system according to claim 13, wherein the at least one processor is configured to capture at least one of global positioning system (GPS) data, thermal data, pressure data, air quality data, solar intensity data, wind speed data, and building control points comprising at least one of Quick Response (QR) codes and computer vision targets adapted to be adhered to the building, for each of at least a subset of the plurality of individual local images of the building façade.

18. The system according to claim 13, wherein the at least one processor is configured to capture location information corresponding to each of at least a subset of the plurality of individual local images of the building façade using a local coordinate system.

19. The system according to claim 13, wherein the at least one processor is configured to overlay a plurality of user-selectable icons on the orthomosaic, each of the icons, when activated by a user, causing a stored local image of a corresponding location on the building façade to be displayed.

20. The system according to claim 13, wherein the at least one processor is configured to compare the local image positions and the orthomosaic with stored historical local image positions and an orthomosaic of the building façade for determining how a condition of the building façade has changed over time.

21. The system according to claim 13, wherein the at least one processor is configured to store the local image positions and the orthomosaic to generate a time-based digital record of structural characteristics of the building façade for visually comparing and contrasting conditions of the building façade over time.

22. A computer program product for facilitating building façade inspection, the computer program product comprising a non-transient computer readable storage medium having computer readable program code embodied thereon, the computer readable program code, when executed on at least one processor, causing the at least one processor:
to obtain a plurality of individual local images of a building façade acquired by an unmanned aerial vehicle;
to create local image positions and an orthomosaic from at least a subset of the plurality of individual local images of the building façade and at least one of a plurality of two- or three-dimensional data relating to the building façade, and features and dimensions indicated in a computer-aided design drawing of the building façade;
to generate a visual image database that correlates each local image position to a corresponding user-selectable link for accessing and presenting a close-up of that image location to a user, the visual image database including one or more non-nadir local images;
to display an overall combined image of the building façade, with the visual image database overlaying the orthomosaic; and
to add a plurality of user-interactive elements to the visual image database, each of the user-interactive elements correlating a prescribed region of interest in the orthomosaic with at least one of the plurality of individual local images corresponding to the prescribed region of interest on the building façade.
